(19) United States
(12) Patent Application Publication
(10) Pub. No.: US 2016/0046193 A1
(43) Pub. Date: Feb. 18, 2016

(54) HYBRID POWERTRAIN WITH MULTIPLE GENSETS AND ELECTRIC DRIVE AXLES

(71) Applicant: John Hank Park, Fredericksburg, VA (US)

(72) Inventor: John Hank Park, Fredericksburg, VA (US)

(21) Appl. No.: 14/460,779

(22) Filed: Aug. 15, 2014

(51) Int. Cl. B60L 11/12; B60W 10/06; B60W 10/08; B60W 20/00

(52) U.S. Cl. CPC B60L 11/12; B60W 20/10; B60W 10/06; B60W 10/08; Y10S 903/93

(57) ABSTRACT

A hybrid powertrain for electric all-wheel drive multi-axle vehicles includes multiple gensets, a genset controller, a battery pack, electric drive units for each wheel, and motor controllers for each motor-generator in the electric drive unit. Each electric drive axle includes the left and right electric drive units that drive the left and right wheels independently without any mechanical coupling between the two units. Running as many gensets as necessary translates to improved fuel economy and reduced emissions. Electrically driving each wheel independently provides simplified all-wheel drive system especially if the number of axles is three or more. Electric modulation of each wheel independently provides a TCS (Traction Control System) without the need for conventional brake-based TCS.

### BACKGROUND OF THE INVENTION

1. Field of the Invention

This invention relates to a hybrid powertrain for electric all-wheel drive vehicles.

2. Background of the Invention

It is challenging to increase the fuel economy of a heavy AWD (all-wheel drive) vehicle because of following reasons. First, such vehicle has a relatively big engine which consumes significant amount of fuel even when it is idling. Second, the already complex and heavy AWD drivetrain would get even more complex and heavier if the number of axles is increased from two to three or more. Therefore, it would be desirable to have a multi-engine powertrain in which only as many engines are used as necessary. It would be also desirable to electrically drive each and every wheel independently such that there is no mechanical connection between the axles and between the wheels, simplifying the all-wheel drive system.

### BRIEF SUMMARY OF THE INVENTION

It is an object of the present invention to provide a hybrid powertrain with multiple gensets and with independent electric drive axles so that the fuel efficiency is increased and that the all-wheel drive system is simplified.

According to an aspect of the present disclosure, a multiple genset hybrid powertrain supplies torque to a plurality of axles. The hybrid powertrain includes a plurality of gensets, a genset controller, a plurality of motor controllers, a plurality of electric drive units, and a battery pack.

The genset controller turns on as many gensets as needed according to the traction demand of the vehicle. The genset controller also modulates the throttle opening of the operating gensets.

Each electric drive axle includes the left and right electric drive units that drive the left and right wheels independently without any mechanical coupling between the two units. Each electric drive unit consists of a motor-generator and a gearbox. The output from the gearbox is a CV (constant velocity joint) which is coupled to a wheel through a half shaft.

A motor controller is assigned to each electric drive unit. The motor controller modulates the electric power to the electric drive unit in coordination with the genset controller. In addition, the motor controller can functions as a TCS (traction control system) by modulating the electric power when the over-spinning of a wheel is detected by the wheel speed sensors. This eliminates the need for expensive conventional hydraulic brake-based TCS.

### BRIEF DESCRIPTION OF THE SEVERAL VIEWS OF THE DRAWING

The foregoing and additional objects and advantages of the invention will become more apparent as the following detailed description is read in conjunction with the accompanying drawings wherein like reference characters denote like parts in all views and wherein:

FIG. 1 is a schematic illustration of an electric all-wheel drive hybrid vehicle;

FIG. 2 is a schematic illustration of a genset that includes an internal combustion engine and an electric generator;

FIG. 3 is a schematic illustration of an electric drive unit that includes a motor-generator and a gearbox;

FIG. 4 schematically illustrates an embodiment of the invention applied to a 4×4 vehicle; and

FIG. 5 schematically illustrates an embodiment of the invention applied to a 6×6 vehicle.

FIG. 6 schematically illustrates an embodiment of the invention applied to a 10×10 vehicle.

### DETAILED DESCRIPTION OF THE INVENTION

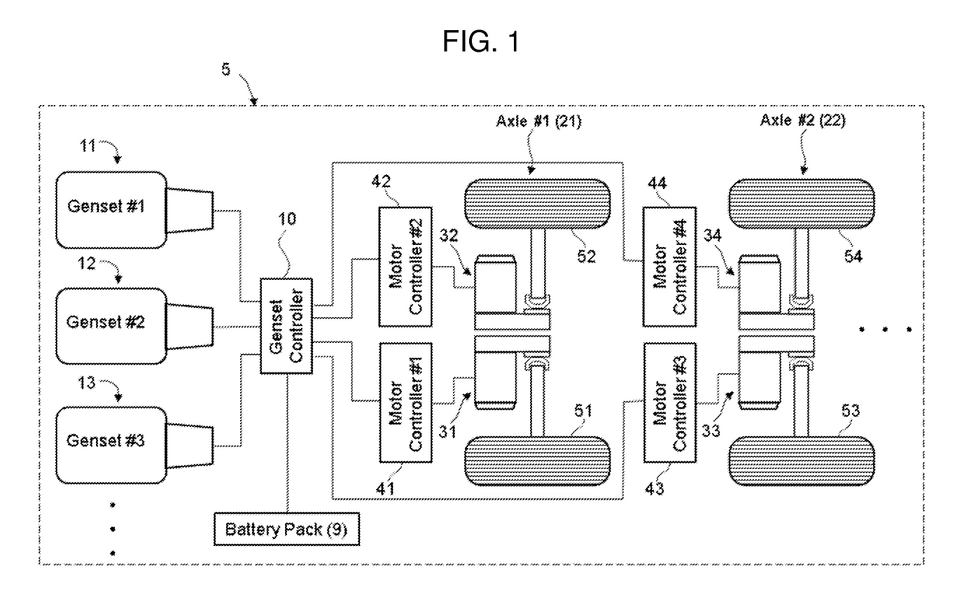

Referring to the drawings in which like elements are identified with identical numerals throughout, FIG. 1 illustrates a hybrid powertrain 5 for an electric all-wheel drive vehicle. The hybrid powertrain 5 includes a plurality of gensets (11, 12, 13, . . . ) that generates electric power for a plurality of electric drive axles (21, 22, . . . ). The genset controller 10 is programmed to turn on or off as many gensets (11, 12, 13, . . . ) as needed based on the traction demand of the vehicle. The genset controller 10 is also programmed to modulate the throttle opening of the gensets (11, 12, 13, . . . ). The genset controller 10 supplies electric power to a plurality of the motor controllers (41, 42, 43, 44, . . . ) which modulates the electric power to the electric drive axles (21, 22, . . . ). The battery pack 9 is coupled to the genset controller 10. The battery pack 9 has a plurality of rechargeable battery cells (not shown). At the peak demand of traction, the electric power from the battery pack 9 can be supplied to the motor controllers (41, 42, 43, 44, . . . ) through the genset controller 10.

The electric drive axle 21 includes the left-side electric drive unit 31 and the right-side electric drive unit 32 that drive the left wheel 51 and the right wheel 52 respectively Likewise, the electric drive axle 22 includes the left-side electric drive unit 33 and the right-side electric drive unit 34 that drive the left wheel 53 and the right wheel 54 respectively. Any additional axles have the identical structure. The wheels (51, 52, 53, 54, . . . ) are independently driven by the electric drive units (31, 32, 33, 34, . . . ) without any mechanical coupling between them, thus forming an independent all-wheel driving system.

The motor controllers (41, 42, 43, 44, . . . ) are programmed to modulate the electric power to the electric drive units (31, 32, 33, 34, . . . ) in coordination with the genset controller 10. In addition, the motor controllers (41, 42, 43, 44, . . . ) can function as a TCS (traction control system) by modulating the electric power when the wheel speed sensors (not shown) have detected that one or more driven wheels are spinning significantly faster than the other wheels. On the other hand, the conventional brake-based TCS suppresses the over-spinning of a wheel(s) by actively applying the brake(s) for the wheel(s). Therefore, this invention makes the TCS possible without employing the conventional brake-based TCS.

FIG. 2 illustrates the genset 11. The genset 11 consists of the internal combustion engine 11a and the generator 11b. Other gensets (12, 13, . . . ) have the same structure.

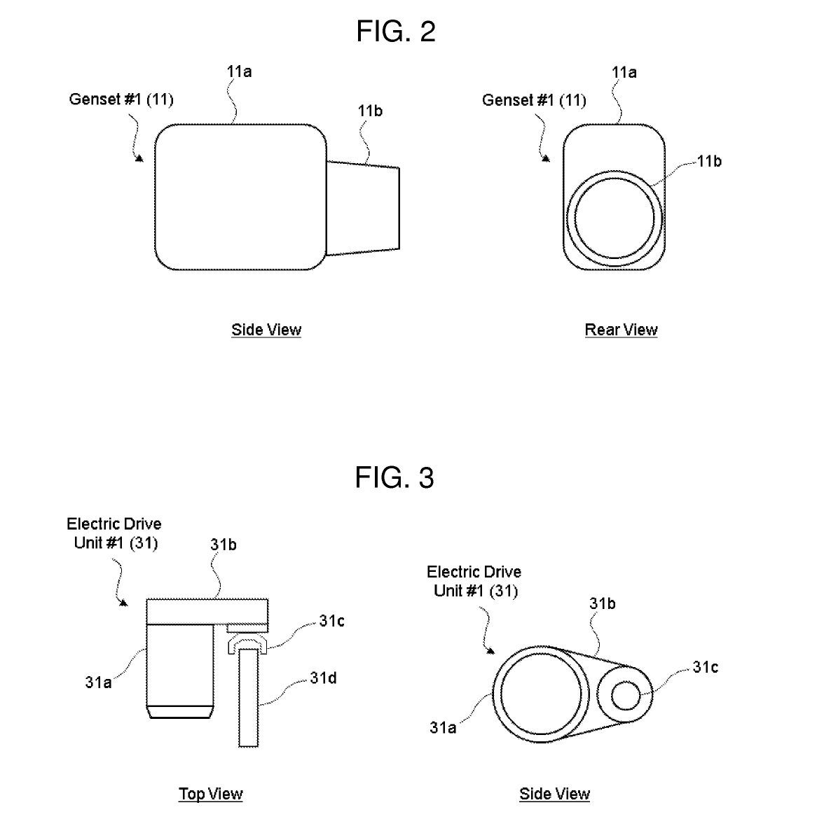

FIG. 3 illustrates the electric drive units 31. The electric drive units 31 consists of a motor-generator 31a, a gearbox 31b, a CV (constant velocity) joint 31c, and a half shaft 31d. The output shaft (not shown) of the motor-generator 31a is coupled to the input shaft (not shown) of the gearbox 31b. The output shaft (not shown) of the gearbox 31b is coupled to the CV joint 31c. The CV joint 31c is coupled to the half shaft 31d. Other electric drive units (32, 33, 34, . . . ) have the same structure. The gearbox 31b reduces the speed of the motor-generator to an appropriate level. When the vehicle is coasting, the motor-generator 31a generates the electric power which is stored in the battery pack 9.

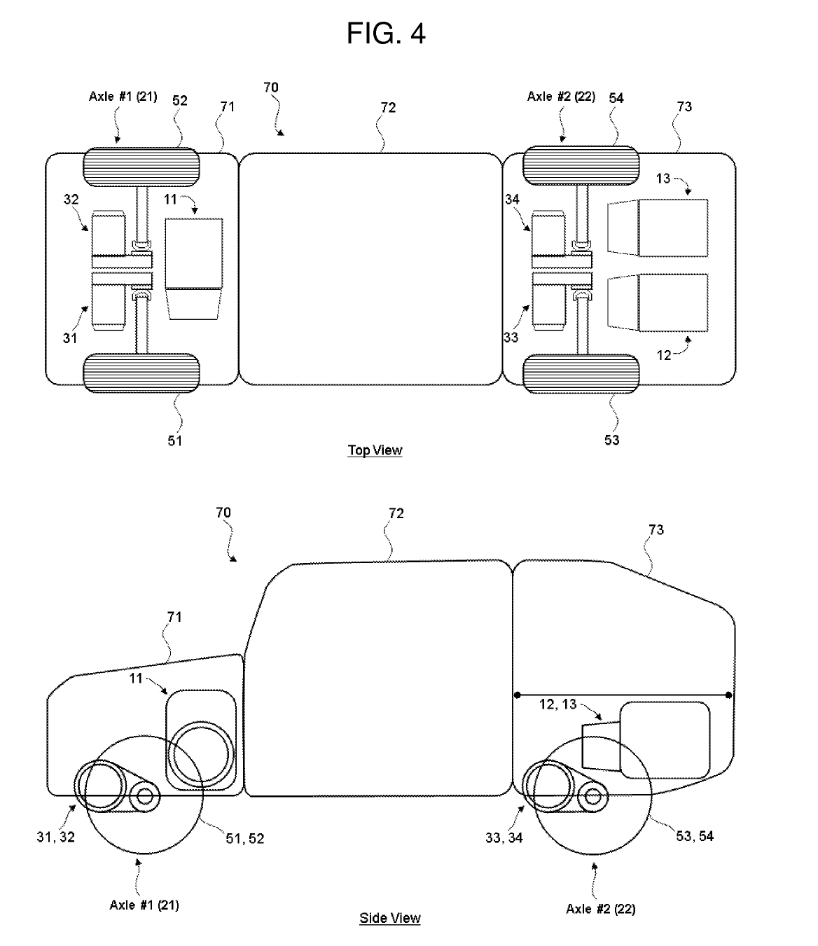

FIG. 4 illustrates the application of the invention to a 4×4 vehicle 70. The front module 71 of the vehicle 70 houses the front axle 21 and the genset 11. The rear/cargo module 73 of the vehicle 70 houses the rear axle 22 and the gensets 12 and 13. It should be noted that no drivetrain components pass through or underneath the cab module 72. On the other hand, conventional mechanical drivetrain components (e.g. transfer case, inter-axle differentials) are positioned underneath the cab module, causing a packaging issue or an overheating issue. FIG. 4 illustrates that the gensets can be positioned or oriented in any available space in the front module 71 and/or in the rear/cargo module 73. The front axle 21 includes the left electric drive unit 31 driving the left wheel 51 and the right electric drive unit 32 driving the left wheel 52. The rear axle 22 includes the left electric drive unit 33 driving the left wheel 53 and the right electric drive unit 34 driving the left wheel 54.

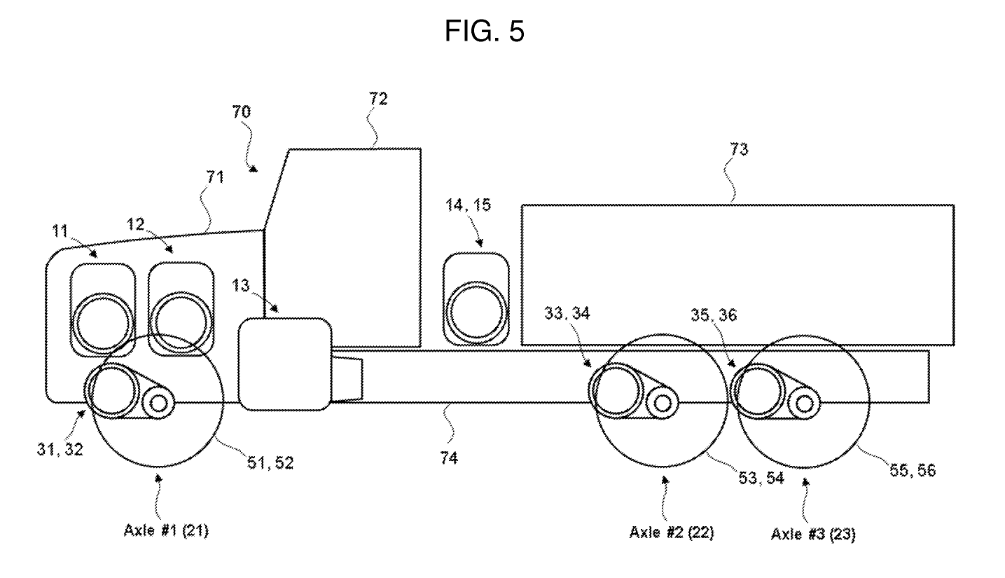

FIG. 5 illustrates the application of the invention to a 6×6 vehicle 70. The front module 71 of the vehicle 70 houses the first axle 21 and the gensets 11, 12 and 13. Additional gensets 14 and 15 are mounted onto the frame 74. The rear/cargo module 73 is mounted onto the frame 74. The second axle 22, the third axle 23 are mounted onto the frame 74. FIG. 5 illustrates that the gensets can be positioned or oriented in any available space in the front module 71, in the rear/cargo module 73, or onto the frame 74. The first axle 21 includes the left electric drive unit 31 driving the left wheel 51 and the right electric drive unit 32 driving the right wheel 52. The second axle 22 includes the left electric drive unit 33 driving the left wheel 53 and the right electric drive unit 34 driving the right wheel 54. The third axle 23 includes the left electric drive unit 35 driving the left wheel 55 and the right electric drive unit 36 driving the right wheel 56.

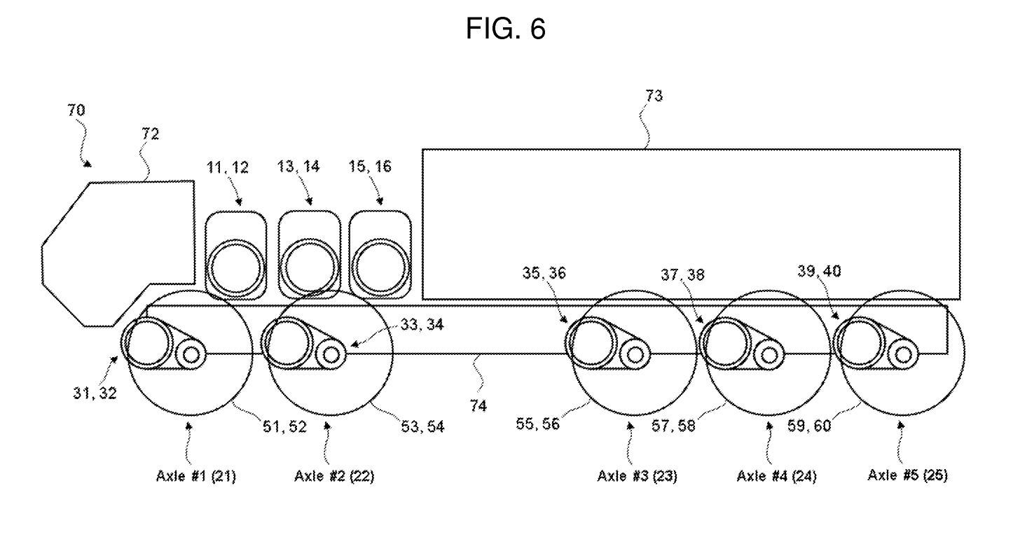

FIG. 6 illustrates the application of the invention to a 10×10 vehicle 70. The front module 71 and the rear/cargo module 73 are mounted onto the frame 74. The axles 21 through 25 are mounted onto the frame 74. The gensets 11 through 16 are mounted onto the frame 74. FIG. 6 illustrates that the gensets can be positioned or oriented in any available space in the vehicle 70 and that the axles 21-25 can be located anywhere along the vehicle. The first axle 21 includes the left electric drive unit 31 driving the left wheel 51 and the right electric drive unit 32 driving the right wheel 52. The second axle 22 includes the left electric drive unit 33 driving the left wheel 53 and the right electric drive unit 34 driving the right wheel 54. The third axle 23 includes the left electric drive unit 35 driving the left wheel 55 and the right electric drive unit 36 driving the right wheel 56. The fourth axle 24 includes the left electric drive unit 37 driving the left wheel 57 and the right electric drive unit 38 driving the right wheel 58. The fifth axle 25 includes the left electric drive unit 39 driving the left wheel 59 and the right electric drive unit 40 driving the right wheel 60.

This invention will provide following benefits when compared to the conventional mechanical powertrain:

Running as many gensets as necessary translates to increased fuel economy and reduced emissions.

Since there is no mechanical connection between the gensets and the electric drive axles, the gensets can be positioned or oriented (north-south versus east-west orientation) in any available space.

Comparison of FIG. 5 and FIG. 6 demonstrates that the independent nature of the electric drive unit makes it easy to add any number of electric drive axles to the vehicle. Even though it is not illustrated here, it is easy to build an 12×12 (six axle) all-wheel drive vehicles based on this invention. On the other hand, adding a driving axle to a vehicle with conventional mechanical drivetrain requires the replacement of major drivetrain components such as the transfer case, propeller shaft, and inter-axle differentials.

Since each wheel is independently driven by the electric drive unit coupled to it, this invention provides an independent driving of all wheels, resulting in a simplified all-wheel drive system. Since the motor controllers can individually modulate the electric power to the electric drive units to counter the over-spinning of any wheels, this invention can function as a TCS (traction control system) without the need for conventional brake-based TCS.

The employment of multiple gensets and multiple electric drive units means high commonality and maintainability of the components.

Since there are multiple gensets and multiple electric drive units, the vehicle can continue operating even with couple of damaged gensets and/or electric drive units. This translates to increased availability or survivability of the vehicle.

In the case of military vehicles with conventional mechanical drivetrain, the drivetrain passes through the gap between the cab module and the V-shaped belly armor kit (let's call this a “V-belly armor” from now on). Since the V-belly armor blocks the airflow to the drivetrain components such as the transfer case and the inter-axle differentials, the drivetrain components are prone to overheat. In addition, it is difficult to access those drivetrain components blocked by the V-belly armor, and therefore it is difficult to perform a routine maintenance of them. This invention will eliminate the drivetrain overheating issue, because there are no drivetrain components except the electric cable that pass under or through the cab module.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

The invention claimed is:

1. A hybrid powertrain for a vehicle that has at least two axles, the hybrid powertrain comprising:
at least two gensets each having: an internal combustion engine and an electric generator driven by the internal combustion engine;
at least two electric drive axles each having: a left electric drive unit, a left wheel driven by the left electric drive unit, a right electric drive unit, and a right wheel driven by the right electric drive unit;
wherein each electric drive unit has an electric motor-generator and a gearbox coupled between the electric motor-generator and the wheel through a half shaft;
a genset controller coupled between the gensets and a motor controllers;
a plurality of motor controllers coupled between the genset controller and the motor-generators of the electric drive units; and
a battery pack coupled to the genset controller;
wherein the battery pack has a plurality of rechargeable battery cells.

2. The hybrid powertrain of claim 1, wherein the genset controller is programmed to turn on or off the appropriate number of the gensets based on the traction demand of the vehicle.

3. The hybrid powertrain of claim 1, wherein the genset controller is programmed to modulate the throttle opening of the running engines of the gensets based on the traction demand of the vehicle.

4. The hybrid powertrain of claim 1, wherein the motor controllers are programmed to modulate the electric power to the electric drive units in conjunction with the genset controller based on the traction demand of the vehicle.

5. The hybrid powertrain of claim 1, wherein the motor controllers are programmed to modulate the electric power to the electric drive units in conjunction with the wheel speed sensors so that the over-spinning of the wheel(s) is suppressed.
